(19) United States
(12) Patent Application Publication
(10) Pub. No.: US 2024/0025769 A1
(43) Pub. Date: Jan. 25, 2024

(54) Water Catalyzed Nitrate Fixation of Atmospheric Nitrogen

(71) Applicant: MARK BANISTER, TUCSON, AZ (US)

(72) Inventor: MARK BANISTER, TUCSON, AZ (US)

(21) Appl. No.: 18/375,824

(22) Filed: Oct. 2, 2023

Related U.S. Application Data
(63) Continuation-in-part of application No. 16/073,708, filed on Jul. 27, 2018, now Pat. No. 11,771,017.
(60) Provisional application No. 62/289,022, filed on Jan. 29, 2016.

(51) Int. Cl. C02F 1/28; D03D 15/292; D04H 1/4382; D06N 3/00; D06N 3/12; D03D 15/50; D06M 15/55; D21H 19/12

(52) U.S. Cl. CPC C02F 1/288; D03D 15/292; D04H 1/43828; D06N 3/0011; D06N 3/12; D03D 15/50; D06M 15/55; D21H 19/12; D10B 2505/00; D06N 2209/141; D06N 2209/142; D10B 2401/022; D06N 2211/02; D06N 2201/04; D06M 2101/04

(57) ABSTRACT

A woven fabric formed of fabric fibers or threads coated with a hydrogel, wherein said hydrogel is not crosslinked or is partially crosslinked to the fabric fibers or thread, wherein the hydrogel has a number of excess reactive molecules that are available for a reaction with one or more molecules solvated in an aqueous solution, and wherein the reactive molecules of the hydrogel can reversibly bond with the molecules solvated in an aqueous solution, such that the reactive molecules of the hydrogel attract the molecules solvated in aqueous solution when the hydrogel coated fabric substrate is exposed to an aqueous solution.

### CROSS REFERENCE TO RELATED APPLICATIONS

This application is a continuation-in-part of US Patent Application Ser. No. 16/073,708, filed, Jul. 27, 2018, which in turn is a 371 application of PCT International Patent Application Serial No. PCT/US2017/15663, filed Jan. 30, 2017, which in turn claims priority from U.S. Provisional Application Ser. No. 62/289,022 filed Jan. 29, 2016, the contents of which are incorporated herein by reference in their entirety.

### BACKGROUND OF THE INVENTION

In our parent application, we disclose a fabric material formed of fibers or threads coated with a polymer material, which polymer material has a number of excess reactive molecules that are available for reaction with one or more molecules solvated in an aqueous solution.

As so described, the fabric material has utility in use in conserving irrigation water, for removing solvent molecules from aqueous solution, and for remediation of soils and water. We have now found that these and other polymer materials advantageously can be used as a vehicle to fix nitrogen in the soil.

The Nitrogen Cycle is a biogeochemical process through which nitrogen is converted into many forms, consecutively passing from the atmosphere to the soil to organism and back into the atmosphere. It involves several processes such as nitrogen fixation, nitrification, denitrification, decay and putrefaction.

Nitrogen gas exists in both organic and inorganic forms. Organic nitrogen exists in living organisms, and they get passed through the food chain by the consumption of other living organisms. Inorganic forms of nitrogen are found in abundance in the atmosphere. This nitrogen is made available to plants by symbiotic bacteria which can convert the inert nitrogen into a usable form—such as nitrites and nitrates.

Nitrogen undergoes various types of transformation to maintain a balance in the ecosystem. In Agriculture Nitrogen containing fertilizers are used extensively to increase plant growth and crop production. The nitrogen in many straight and compound fertilizers is in the form of ammonium NH₄⁺ cation but, depending on soil conditions including aeration, temperature, and drainage, it is quickly changed by bacteria in the soil to nitrate NO₃⁻ anion through nitrification. Many crop plants, e.g., cereals, take up and respond to the NO₃⁻ anions quicker than the NH₄⁺ cations, but other crops, e.g., grass and potatoes, are equally responsive to NH₄⁺ and NO₃⁻ ions. The ammonium cation is held in the soil complex at the expense of calcium and other loosely held bases which are lost in the drainage water. Hydrogen ions are also produced as ammonium is nitrified.

Common Nitrogen fertilizers in agriculture use are:

Ammonium nitrate AN 33.5%-34.5% N. This is a very widely used fertilizer for applying on to the growing crop top-dressing. Half the nitrogen as nitrate is very readily available. It is marketed in a granular form to resist moisture absorption. Ammonium nitrate fertilizer is a hazard due to its detonation potential and ability to act as an oxidizing agent fueling a fire. Risk is managed through safe storage and handling and being kept well away from combustible organic matter or incompatible materials. Because of the ammonium present, it has an acidifying effect to the soil it is applied on.

Calcium ammonium nitrate 26%-28% N. This granular fertilizer is a mixture of ammonium nitrate and calcium nitrate. It has a lower acidifying potential when added to the soil.

Urea 46% N. This is the most concentrated solid nitrogen fertilizer and sometimes used for aerial top-dressing. In the soil, urea changes to ammonium carbonate which may temporarily cause a harmful local high pH. Nitrogen, as ammonia, may be lost from the surface of chalk or limestone soils, or light sandy soils, when urea is applied as a top-dressing during a period of warm, often windy, weather. When it is washed or worked into the soil, it is as effective as any other nitrogen fertilizer and is most efficiently utilized on soils with adequate moisture content, so that the gaseous ammonia can go quickly into solution. In dry conditions in the height of summer it is probably better to use ammonium nitrate. Chemical and bacterial action changes it to the ammonium and nitrate forms. If applied close to seeds, urea may reduce germination. Future use of urea fertilizers in England has been subject to a recent government consultation. The context was a need to achieve a 16% reduction in ammonia emission by 2030 in comparison to the 2005 level. Certain future restrictions on use and timings of solid and liquid forms, with and without urease inhibitors, are expected to be implemented from 2023 onwards.

Ammonium sulphate 21% N. At one time, as a fertilizer, this was the main source of nitrogen. However, sulphate of ammonia is seldom used now. It consists of whitish, needle-like crystals and has a greater acidifying action on the soil than other nitrogen fertilizers. Some nitrogen may be lost as ammonia when it is top-dressed on chalk soils. It also contains 60% SO3−.

Sodium nitrate 16% N. This fertilizer is obtained from natural deposits in Chile and is usually marketed as moisture-resistant granules. Nitrogen is readily available, and the sodium is of value to some fresh produce crops. It is expensive and is not widely used. It also contains 26% Na.

Calcium nitrate 15.5% N. This is a double salt of calcium nitrate and ammonium nitrate in granular form. It is mainly used in continental Europe.

Aqueous nitrogen solutions 18%-37% N. These are usually solutions of mixtures of urea and ammonium nitrate are commonly used on farm crops liquid fertilizers, often with other nutrients in formulated compounds. Foliar applications of liquids can often be targeted in later crop growth stages.

Various attempts have been made to produce slow-acting nitrogen fertilizers. Such products have included resin- or polymer-coated granules of ammonium nitrate 26% N, sulfur-coated urea 36% N, urea condensates and urea formaldehydes 30%-40% N. These types of fertilizer are used more in amenities and production horticulture than farm agricultural crops.

Unfortunately, fertilizer runoff as well as leaching into the ground and the subsequent groundwater have led to significant problems with water pollution. The nutrients from the fertilizer stimulate algae growth and the resultant algae blooms can have disastrous effects on water ecosystems. The algae takes up and starves large aquatic areas of oxygen and creates dead zones where nothing can live. Beyond this there are well known health issues with humans and animals if drinking water contains high amounts of nitrates or nitrites.

Water Conservation is of growing importance throughout the world as the growing population is putting more stress than ever on existing water infrastructures and resources. This invention pertains to new types of materials and new approaches to conserve water and remediate already polluted water especially in the agriculture and mining industries. Current water purification technologies such as Reverse Osmosis and Electro Dialysis are expensive to build, are energy and cost prohibitive to operate especially in underdeveloped countries, as well as producing large quantities of brine and wastewater.

A passive or low energy use system of water remediation would greatly reduce the initial up front building costs as well as reduce ongoing operating expense and water waste. The described invention solves cost problems and is highly efficient at conserving and remediating water. Versions of the described invention utilize a polymer hydrogel wherein the polymer is non soluble, is porous and contains either crosslinked or trapped reactive molecules with available electrons and or protons, and/or positive molecular charges, and/or negative molecular charges that alone or in combination attract targeted pollutants. The pollutants can be in water or in the atmosphere or in the ground. The most efficient method we have found is when pollutants are solubilized in water, however this invention works with solvents other than water and is not limited in its scope to use in or with water specifically.

### SUMMARY OF THE INVENTION

To stop these health and environmental pollutants a different approach to nutrient production and application for agriculture use is needed. Nutrients need to be applied and kept in the root zone of the crop and plants. Additionally, there needs to be a product that does not allow excess nutrients to run off or percolate deep into the soils and groundwater. This invention solves this problem by adding more Nitrogen nutrients into the soil through scavenging Nitrogen from the atmosphere, where it is most abundant, and converts the Nitrogen molecules so that they become available for use by plants. This approach does this in a way that parallels the Nitrogen cycle with an added effect of more available Nitrogen and is symbiotic to the Nitrogen cycle. Furthermore, this effect is catalyzed by water allowing Nitrogen for the plant to only be produced when it can be absorbed by the plant. This eliminates excess Nitrogen containing fertilizers and subsequent runoff or ground leaching of harmful Nitrates or Nitrites.

By using non soluble crosslinked polymers with excess reactive molecules such as Amines and Hydroxyls it is possible to fix nitrogen via nitrification and ammonification with the presence of water as the catalyst. This occurs at the water, polymer and nitrogen boundary or surface layer without the presence of nitrifying bacteria. This invention works at ambient temperatures at the root zone of the plant and or crops when crosslinked polymer is added to the soil. In addition to the nutrient conversion benefit, the crosslinked polymer readily absorbs water and then slowly releases it. The absorption and release of water beyond being beneficial in dry arid climates, causes a large physical swelling and contracting of the polymer creating aeration of the soil around it which in turn allows fresh air in with more nitrogen available for conversion and uptake by the plant or plants.

Another benefit is that once the crosslinked polymer is swollen with water, as it releases the water and the water is evaporating, it has a cooling temperature effect around the surface of the crosslinked polymer and its surroundings. This cooling can be substantial as much as 20 degrees less than the ambient air in dry climates and thus reduces heat stress in plants during periods of hot weather. Furthermore, the cooling effect slows down the evaporation rate and may cause recondensation of evaporating water droplets. The subsequent slowdown of the evaporative process has reduced irrigation water needs by as much as 50 percent in both crop and turf applications.

The crosslinked polymer is a 3D polymer matrix and is non soluble in water.

The polymer material is a hydrogel composed of crosslinked polymers and is not soluble in a solvent such as water. The polymer is formulated by crosslinking two or more monomers and or polymers in a method so that once crosslinked they form a 3 dimensional non soluble polymer network. Crosslinking can be accomplished in many ways that are well known in the art of polymer chemistry dependent on the polymer chains and reactive molecule species or catalyst used for the crosslinking reaction. Typically, a cross-′ink is a bond that links one polymer chain to another. They can be covalent bonds or ionic bonds. Polymer chains can refer to synthetic polymers or natural polymers such as proteins. When the term cross-linking is used in the synthetic polymer science field, it usually refers to the use of cross-links to promote a difference in the polymers' physical properties. When crosslinking is used in the biological field, it refers to the use of a probe to link proteins together to check for protein—protein interactions, as well as other creative cross-linking methodologies.

Cross-linking is used in both synthetic polymer chemistry and in the biological sciences. Although the term is used to refer to the linking of polymer chains for both sciences, the extent of crosslinking and specificities of the crosslinking agents vary. Of course, with all science, there are overlaps, and the following delineations are a starting point to understanding the subtleties. When cross links are added to long rubber molecules, the flexibility decreases, the hardness increases, and the melting point increases as well.

When polymer chains are linked together by cross-links, they lose some of their ability to move as individual polymer chains. For example, a liquid polymer such as resin or even melted cheese which contains protein polymers where the chains are freely flowing can be turned into a solid or gel by cross-linking the chains together.

In polymer chemistry, when a synthetic polymer is said to be “cross-linked”, it usually means that the entire bulk of the polymer has been exposed to the cross-linking method. The resulting modification of mechanical properties depends strongly on the cross-link density. Low cross-link densities decrease the viscosities of polymer melts. Intermediate cross-link densities transform gummy polymers into materials that have elastomeric properties and potentially high strengths. Very high cross-link densities can cause materials to become very rigid or glassy, such as phenol-formaldehyde materials.

Cross-links can be formed by chemical reactions that are initiated by heat, pressure, change in pH, or radiation. For example, mixing of an unpolymerized or partially polymerized resin with specific chemicals called crosslinking reagents results in a chemical reaction that forms cross-links. Cross-linking can also be induced in materials that are normally thermoplastic through exposure to a radiation source, such as electron beam exposure, gamma-radiation, or UV light. For example, electron beam processing is used to cross-link the C type of cross-linked polyethylene. Other types of cross-linked polyethylene are made by addition of peroxide during extruding type A or by addition of a cross-linking agent e.g. vinyl-silane and a catalyst during extruding and then performing a post-extrusion curing. The chemical process of vulcanization is a type of cross-linking that changes rubber to the hard, durable material associated with car and bike tires. This process is often called sulfur curing; the term vulcanization comes from Vulcan, the Roman god of fire. This is, however, a slower process. A typical car tire is cured for 15 minutes at 150° C. However, the time can be reduced by the addition of accelerators such as 2-benzothiazolethiol or tetramethyl thiuram disulfide. Both of these contain a sulfur atom in the molecule that initiates the reaction of the sulfur chains with the rubber. Accelerators increase the rate of cure by catalyzing the addition of sulfur chains to the rubber molecules.

Cross-links are the characteristic property of thermosetting plastic materials. In most cases, cross-linking is irreversible, and the resulting thermosetting material will degrade or burn if heated, without melting. Especially in the case of commercially used plastics, once a substance is cross-linked, the product is very hard or impossible to recycle. In some cases, though, if the cross-link bonds are sufficiently different, chemically, from the bonds forming the polymers, the process can be reversed. Permanent wave solutions, for example, break and re-form naturally occurring cross-links, disulfide bonds between protein chains in hair.

Chemical covalent cross-links are stable mechanically and thermally, so once formed are difficult to break. Therefore, cross-linked products like car tires cannot be recycled easily. A class of polymers known as thermoplastic elastomers rely on physical cross-links in their microstructure to achieve stability, and are widely used in non-tire applications, such as snowmobile tracks, and catheters for medical use. They offer a much wider range of properties than conventional cross-linked elastomers because the domains that act as cross-links are reversible, so can be reformed by heat. The stabilizing domains may be non-crystalline as in styrene-butadiene block copolymers or crystalline as in thermoplastic co-polyesters. The compound bis triethoxysilylpropyl tetrasulfide is a cross-linking agent: the siloxy groups link to silica and the polysulfide groups vulcanize with polyolefins.

Many polymers undergo oxidative cross-linking, typically when exposed to atmospheric oxygen. In some cases, this is undesirable and thus polymerization reactions may involve the use of an antioxidant to slow the formation of oxidative cross-links. In other cases, when formation of cross-links by oxidation is desirable, an oxidizer such as hydrogen peroxide may be used to speed up the process.

It is possible to crosslink polymers and leave an excess of one or more unreacted reactive molecules. One example of this would be in an epoxide reaction where there is a ratio of one or more epoxy reactant molecules that is greater than the number of epoxides. After polymerization crosslinking an amount of unreacted reactive molecules used in the polymerization process will remain un crosslinked and still available for a chemical reaction. These unused molecules can be calculated as mathematical ratios. In another epoxide reaction, a branched polymer with reactive molecules that do not react to the epoxide reaction may be mixed into the formulation of the epoxide wherein the branched polymer gets trapped or entangled with in the reacted epoxy matrix, leaving all of the unreacted reactive molecules available for later use. Another example would be to add into the epoxy mixture prior to polymerization a reactive molecule or material such as but not limited to activated carbon, Oxides such as zinc or titanium, clays, nano powders that react with specific pollutants, Amines, Hydrogens, Carboxylates, Hydroxyls, hyperbranched polymers with hydroxyl or other end units, highly structured or branched dendrimers with reactive end units are another way to increase performance, Oxygen, Fluorine, Thiols etc. this can additionally be used in reverse where some of the branched polymers are end capped with reactive Amines, Hydrogens, Carboxylates, Hydroxyls, Oxygen, Fluorine, Thiols etc. to specifically target molecules in solution. The polymerization reaction can be done several ways such as epoxide reaction, condensation reaction, UV initiated reaction, Thermal reaction etc. and is not meant to limit the scope of the invention. The unreacted molecules that are left after the polymerization reaction or trapped in the polymer matrix are then able to react with water or other solvents and attract the one or more targeted molecules that are being recovered or removed from a solution.

Amine interaction with water is well known, Amines are weak bases. They ionize in aqueous solution to form their corresponding ammonium ion and hydroxide ion by accepting a proton from water. This process when applied as a non-soluble crosslinked polymer additionally adds nitrogen from the atmosphere into the conversion at the water polymer gas boundary or surface.

The conversion appears to be temporary and only in the presence of water, but the plants are able to uptake the nitrogen that has been fixed from this process.

It has been reported that the nitrogen bond in chemical systems occurs when here is evidence of a net attractive interaction between the electrophilic region associated with a covalently or coordinately bound nitrogen atom in a molecular entity and a nucleophile in another, or the same molecular entity. It is the first member of the family of pnictogen bonds formed by the first atom of the pnictogen family, Group 15, of the periodic table, and is an inter- or intra-molecular non-covalent interaction.

From our experience in making highly engineered smart polymers we know that strong physical and chemical properties can be produced from electrophilic charges both in attraction and repulsion of molecules and now we are able to produce a secondary chemical change by the fixation of nitrogen. There by producing an alternative to applied fertilizers or at the very least reducing the amount of fertilizer needed or applied to a crop and in turn reducing the pollution of water from secondary runoff or percolation into ground water tables is a needed and useful invention.

In a preferred embodiment the crosslinked polymer is cast and or molded into a geometric shape such as but not limited to a cylinder or sphere. This is to allow for easy dispersion into the soil and easy removal of the crosslinked polymer from soil through the use of a screen or other technique that separates the soil from the crosslinked polymer shapes. Casting different shapes also allows for optimization of the expansion and contraction properties of the polymer in order to maximize the most beneficial aeration of the soil.

In another preferred embodiment, the crosslinked polymer is applied to a fabric or cloth with woven or unwoven openings where the cloth can be installed below the soil surface and improve the nitrogen uptake, slow down the evaporation of irrigation water and aerate the soils as it cycles between wet and dry states.

In one embodiment of the invention there is provided a woven fabric formed of fabric fibers or threads coated with a hydrogel, wherein said hydrogel is not crosslinked or is partially crosslinked to the fabric fibers or thread, wherein the hydrogel has a number of excess reactive molecules that are available for a reaction with one or more molecules solvated in an aqueous solution, and wherein the reactive molecules of the hydrogel can reversibly bond with the molecules solvated in an aqueous solution, such that the reactive molecules of the hydrogel attract the molecules solvated in aqueous solution when the hydrogel coated fabric substrate is exposed to an aqueous solution.

In one preferred embodiment the hydrogel may be an epoxy and hydrophilic.

In another preferred embodiment the fabric fibers or thread are made of a synthetic materials selected from the group consisting of polypropylene, polyethylene, polyester, and a copolymer mixtures thereof, or a natural fiber material selected from the group consisting of Jute, Sisal, Hemp, Hessian, cotton, bamboo and a mixture thereof.

In another preferred embodiment the fabric fibers or threads are all of similar size in all of the weave directions, or are of two or more different sizes, wherein at least one size of fabric fibers or thread are woven in one weave direction, and at least one different size of fabric fibers or thread are woven in a different direction to the first size of fabric fibers, or are of two or more different sizes, wherein at least one size of fabric fibers of thread is hydrophilic and a different size of fabric fibers or thread are hydrophobic.

In yet another preferred embodiment, the woven fabric is in a form of a continuous loop belt.

Also provided is a non-woven substrate in a form of fabric fibers or threads coated with a hydrogel, when said hydrogel is not crosslinked or is partially crosslinked to the fabric fibers or thread and includes at least one of the following:
wherein the hydrogel is an epoxy and hydrophilic;
wherein the fabric is made of a synthetic materials selected from the group consisting of polypropylene, polyethylene, polyester, and a copolymer mixture thereof;
wherein the fabric is made of natural fiber material selected from the group consisting of Jute, Sisal, Hemp, Hessian, cotton, bamboo and a mixture thereof; and
wherein the substrate is a paper.

In one preferred embodiment, the fabric fibers are all of similar size, or wherein the fabric fibers are of two or more different sizes.

In another preferred embodiment the substrate is perforated in a geometric pattern, removing between 10-90 percent of the substrate, or the substrate is coated in alternating stripes of hydrophilic hydrogel and hydrophobic polymer gel.

In another preferred embodiment, the substrate is in a form of a continuous loop belt.

Also provided is a method of removing solvated molecules from solution and recovering the molecules and the solution separately using a substrate coated with, a porous polymer gel wherein the polymer gel has a number of excess reactive molecules that are available for a reaction with one or more molecules solvated in a solution, and wherein the reactive molecules of the porous polymer gel can reversibly bond with the molecules solvated in a solution, such that the reactive molecules of the polymer gel attract and remove the molecules solvated in solution when the substrate is exposed to the solution and; wherein the removed molecules can be recovered from the substrate and the substrate can be reused once the molecules are recovered.

In one embodiment, the porous polymer gel coated substrate can be further recharged in another solution, and/or wherein the molecules are recovered by one or more electrochemical reaction.

Also provided is a solution remediation system comprising a substrate coated with a hydrogel having excess reactive molecules, wherein the substrate is one or more components of a continuous moving loop belt and the belt is exposed to one or more solutions in at least one tank with an inlet and outlet, the hydrogel excess reactive molecules reversibly bond, attract, adsorb or remove solvated molecules from the solution in the tank, the molecules removed from solution are recovered from the hydrogel coated substrate by exposing the continuous loop belt to another solution in at least one tank or process in sequence with one or more of the following steps:
drying,
heating,
chilling
electrochemical processes,
chemical processes,
rinsing,
the excess reactive molecules of the hydrogel coated substrate are recharged by at least one of the following;
drying,
heating,
chilling
electrochemical processes,
chemical processes,
rinsing, and
the excess reactive molecule hydrogel coated substrate continuous loop belt is re-exposed to solution to be remediated.

In one embodiment the continuous moving loop belt is exposed to evaporation chamber wherein the solution is evaporated from continuous belt, cooled and condensed to recover the solution.

In one preferred embodiment the solvated molecules to be recovered consist of one or more salts, metals, ions, cations, carbons, CO2, acids, bases, ammonia, nitrates, nitrites, phosphorus, potassium, oil

In another preferred embodiment the inlet has a positive and negative electrodes in electrical connection with a power source and placed before the tank inlet on opposite sides of a tube made of ion separator material attached to the inlet, and/or wherein the one or more tanks have two or more electrodes in electrical connection with a power source and said tank has at least one ion separator isolating at least one electrode from the other, and/or wherein the electrochemical process has a positive and negative electrode placed on opposite sides of the continuous belt, wherein a charge applied to the electrodes generate a charge dynamic that attracts and releases the molecules recovered from solution by said continuous loop belt.

Also provided is a passive solution remediation system wherein a substrate of fibers running predominately in one direction and coated with a hydrogel are placed in such a manner that one end of the substrate is placed in a solution to be remediated and the opposite end is placed in a collection container at a lower level than the solution to be remediated and allowed to siphon or wick the solution from the higher elevated solution down to the lower solution container, and wherein the polymer coated substrate preferably is placed inside a tube to stop evaporation of the solution from the hydrogel coated fibers.

Also provided is a method of conserving irrigation water comprising placing a substrate coated with a polymer gel below the soil surface or planting media surface of one or more plants at a depth ranging from one tenth (0.10) of an inch to forty-eight (48) inches deep, preferably at a depth ranging between one and three inches deep and wherein the substrate is coated with a polymer gel that is hydrophilic, the polymer gel coated substrate has openings for plant roots to grow through, the polymer gel coated substrate allows irrigation water to pass through it when plant is being irrigated, and then slows down the rate of water evaporation from the soil or planting media.

In one preferred embodiment the polymer gel coating the substrate contains excess reactive molecules that adsorb, bond or attract at least one dissolved fertilizer chemical component.

In another preferred embodiment the woven fabric has an open weave with 1-100 threads per inch, and preferably an open weave of between 2 and 14 threads per inch and coated with a hydrogel.

In yet another preferred embodiment the non-woven substrate fabric is perforated to remove a range of 10-90 percent of the substrate, preferably 30-60 percent of the substrate and coated with a hydrogel.

In yet another embodiment there is provided a sub soil surface installed irrigation water conservation system comprising a woven fabric or a non-woven substrate of as above described, having at least one length of drip irrigation tubing attached or in contact with the fabric or substrate in fluid connection with the irrigation system.

In another preferred, embodiment the crosslinked polymer is produced by an epoxy reaction of a linear polymer such as but not limited to polyethylene glycol diglycidyl ether and a branched Polyetheramine containing polymer such as Huntsman tri amine T403, and or a polyethyleneimine and or a branched polyethyleneimine. The amines react with the oxygen end units of the polyethylene glycol diglycidyl ether and form a 3D polymer network. Additionally other diglycidyl ethers such as polypropylene may be used in the polymerization crosslinking reaction. The components can be reversed where the polymer with the oxygen end units can be branched, and a diamine linear polymer is used. However, the more branched the polymer with the reactive Amine end units is the more excess Amines there are available for the desired Nitrogen reactions in the presence of water.

In another preferred embodiment, clays and or oxides are added to the crosslinked polymer to help carry and convert Phosphorus and Potassium nutrients for plants and or crops.

In another embodiment, of the invention the crosslinked polymers are added and tilled into crop soils or fields as a soil amendment.

In another embodiment of the invention, crosslinked polymers are used and applied to boundary areas of a farm or field to reduce or eliminate any water runoff that contains excess fertilizer nutrients.

In another embodiment, the crosslinked polymers can be moved from one location to another location of the farm or fields to enhance the soil with nutrients repeatably.

In yet another preferred embodiment the crosslinked polymers water, nitrogen gas reaction and or interaction may be used as a chemical precursor or alternate low energy method of producing nitrogen based nutrients and chemicals. As current production methods are typically using high energy, heat and or pressure to produce nitrogen-based chemicals for plant nutrients and fertilizers.

### BRIEF DESCRIPTION OF THE DRAWINGS

Further features and advantages of the present invention can be seen from the following detailed description, taken in conjunction with the accompanying drawings:

FIG. 1 illustrates conventional breathing components;

FIG. 2 illustrates preferred weaves in accordance with the present invention;

FIGS. 3A and 3B illustrate two embodiments of perforated non-woven material in accordance with the present invention;

FIG. 4 illustrates a preferred continuous loop of remediation system in accordance with the present invention;

FIGS. 5A and 5B illustrate a water irrigation method conservation system in accordance with the present invention; and

FIG. 6 illustrates a low energy passive water remediation system in accordance with the present invention.

### DETAILED DESCRIPTION OF THE INVENTION

The following description shows several possible versions of materials, types, methods and uses of the disclosed invention.

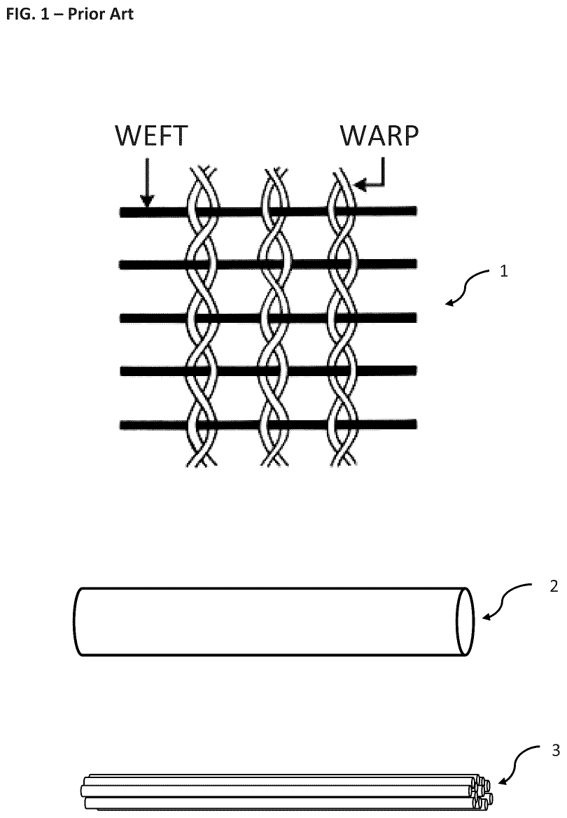

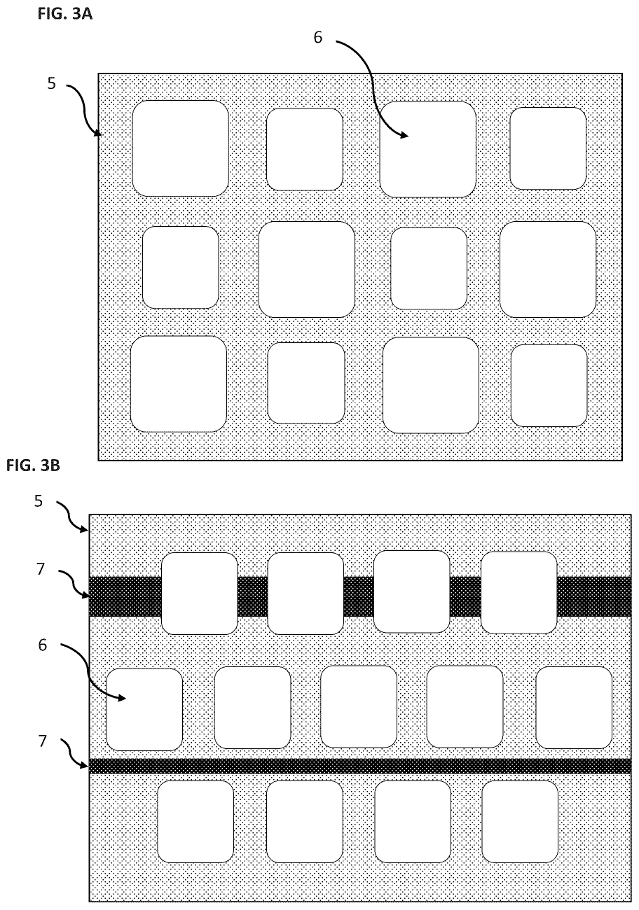

Starting with FIG. 1 detail is shown of the possible weaving components known in the weaving industry as the weft and warp each component can be of similar or different thread and filament type in order to add specific functionality such as flexibility in the bias or angular direction. Another example would be to design the water wicking directionality into the fabric. For example in a preferred embodiment of the invention the weft component is a multifilament thread coated with a hydrophilic polymer hydrogel as shown in FIG. 3 while the warp uses a monofilament thread shown in FIG. 102 that is not coated. The coated multifilament thread allows superior wetting and water to travel easily along its length while the water has a much more difficult time traveling along the warp or monofilament thread.

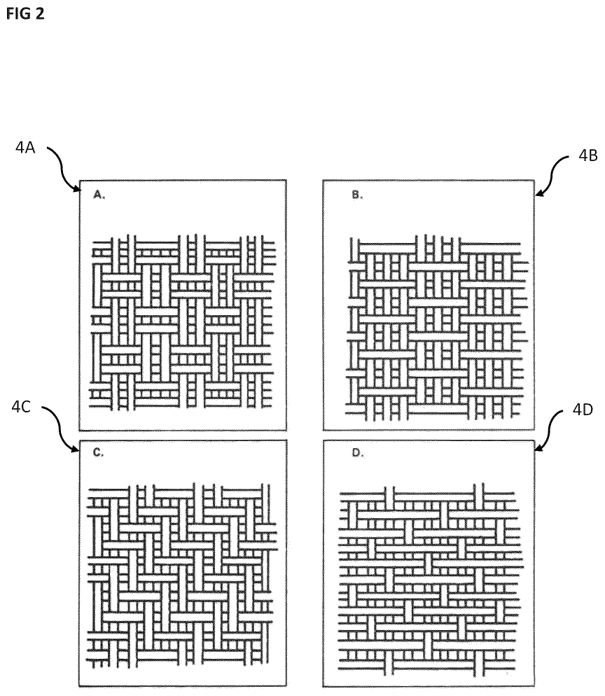

FIG. 2 depicts several possible weave patterns as shown in 4A, 4B, 4C and 4D. While the weave pattern will impart certain attributes such as strength or flexibility in a particular direction, the invention described is not limited by any particular weave pattern. In agriculture or landscape use, the open area of the weave is very important as it dictates the performance of the material as it slows down the water evaporation from the soil. If the open area is too large the water evaporates faster and if the open area is to small it stops evaporation and keeps the plant roots to wet. The ability of plant roots to penetrate through the weave of the material is also of importance and weaves with a thread counts of 6 to 12 per inch offer the optimum performance of both factors. The thread materials dictate the long term in ground stability of the materials, natural threads such as Jute and cotton will eventually deteriorate and degrade over time while synthetic thread materials such as polyester and polyethylene will last many years longer, there are advantages in both for certain applications so the materials used may be many and varied.

FIG. 3 depicts two preferred embodiments of perforated non-woven material or fabric coated with polymer gels. Non-woven materials or fabrics are typically manufactured by putting small fibers together in the form of a sheet or web similar to paper on a paper machine, and then binding them either mechanically as in the case of felt, by interlocking them with serrated needles such that the inter-fiber friction results in a stronger fabric, with an adhesive, or thermally by applying binder in the form of powder, paste, or polymer melt and melting the binder onto the web by increasing temperature. The non-woven material in FIG. 3A is perforated using a geometric shape, as shown in FIG. 3A, of two different sizes and then coated with a hydrophilic polymer hydrogel. The perforations allow plant roots to penetrate through the non-woven material as without the perforations, the non-woven material will not let the plant roots to penetrate or if the material is made so thin that the plant roots can penetrate the non-woven material lacks the structural strength needed to sustain its shape in the ground. FIG. 3B shows examples of a non-woven material coated with stripes of hydrophobic polymer gel and stripes of hydrophilic polymer gel FIG. 3B for the purpose of imparting wicking directionality to the material. This is important if the non-woven material is installed on a slope below the soil surface, the stripes of hydrophobic polymer gel would be installed to run latitudinally across the slope in order to stop water from wicking uncontrolled to the bottom of the slope and running out due to gravity.

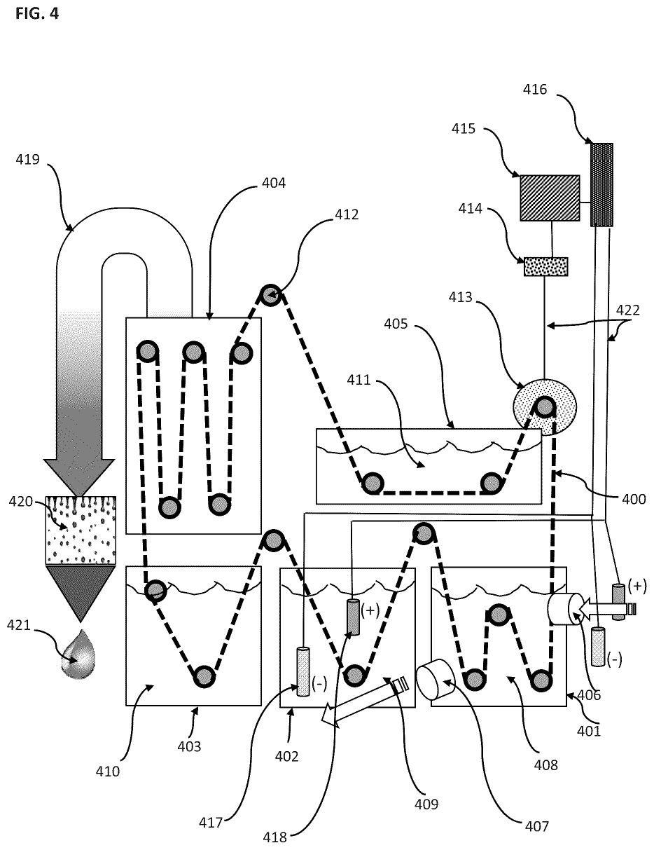

FIG. 4 depicts another preferred embodiment of the disclosed invention wherein the hydrogel coated material is in the form of a continuous loop belt, shown as FIG. 4. The continuous loop belt is a component of a solution processing system wherein the polymer hydrogel's excess reactive molecules are used to remove or separate molecules from a solution. The solution being processed is contained in a tank, 401 that has an inlet 406 and an outlet 407, the continuous loop belt runs through the solution at a speed that allows maximum adsorption and attraction of the target molecules in the solution 408 that is being processed. The continuous loop belt is moved or driven by the motor drive 413 of the system, the motor drive is controlled by a controller 414 that sets or adjusts the speed of the continuous loop belt through the entire system. The controller and motor are powered by a power source shown as 415, the power source also powers the electrochemical controller or a separate power source may be used dependent on the electrochemical processing power needs.

A solution for example, such as water containing iron nitrate, is being processed, it is passed through the first tank with the continuous loop belt, the iron nitrate is adsorbed by the polymer gel excess reactive molecules of the continuous loop belt and the water is now clean and removed. The continuous loop belt is moved into the next tank 402 of the system filled with another solution 409 to solubilize and conduct the iron metal removal from the continuous loop belt. The tank of 402 has two or more electrodes, at least one positive 418 and at least one negative 417 the electrodes are in electrical connection with the electrochemical controller and power source. As the continuous loop belt passes through the tank the Iron metal is deposited on the appropriate electrode and the continuous loop belt exits the tank. The continuous loop belt now enters the next processing tank 403 and is soaked in solution 410 to remove the nitrates, the continuous loop belt then enters an evaporation chamber 404 to evaporate most of the water on the continuous loop belt. The water vapor is collected in a condensation chamber 419 cooled and re-condensed into water 420 and collected as distilled water 421. When the continuous loop belt leaves the evaporation chamber it next enters a recharge tank 405 wherein the continuous loop belts excess reactive molecules are recharged in a solution 411 that matches the chemical charge makeup of the excess reactive molecules that need to be recharged. For example, to recharge amines an ammonia solution works very well. After recharge the continuous loop belt is ready to re-enter the first tank with the solution that is being processed, the continuous loop belt may need to be squeezed between rollers to remove excess ammonia prior to re-entering first tank. The continuous loop belt is driven on and rides on rollers 412 that allow the continuous loop belt to move without friction. In certain processes the described invention may need more or less steps and tanks to be processed and the description is not meant to limit the invention in any way.

Additional electrodes at the inlet side of the tank can be used to attract salts and other cations or ions prior to entering the processing tanks. A preferred embodiment would have an open water source such as a brackish pond the inlet pipe or channel to the first processing tank has a section that is porous to ions such as an ion separator membrane used in batteries, the electrodes are positioned on each side of the ion porous section, at least one positive and at least one negative. The electrodes are controlled by the electrochemical controller and power source. When power is applied, the electrodes attract the cation and ionic salts or other impurities as they travel into the inlet pipe. The ions pass through the ion membrane to the electrodes and are not collected in the inlet. Removing a large portion of dissolved salts from the brackish water entering the system. The high ion concentrate water formed around the electrodes can be kept moving and removed away from the inlet pipe by a pump circulating the pond water.

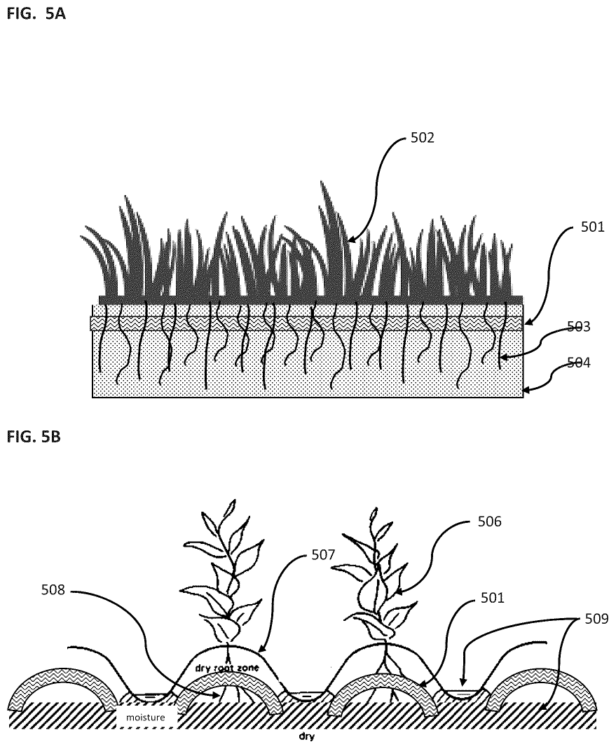

FIG. 5 depicts two more preferred embodiments of the material being used for landscape and agriculture. The hydrogel coated fabric material of the disclosed invention is shown as 501 wherein the hydrogel coated fabric material is placed an inch or so below the surface of a grass lawn 502 and the roots 503 of the lawn or other plants easily penetrate through the material openings, whether the material is woven or non-woven, the roots penetrate deeper into the ground or planting media allowing the lawn above the material to dry while the roots stay moist longer, grow, conserve water and conserve fertilizer below the hydrogel coated fabric material of the disclosed invention.

An agriculture crop plant is depicted as 506 and the drawing shows the crop grown in furrows 507. The hydrogel coated fabric material of the disclosed invention is shown as 501 and placed in such a manner that the crops roots 508 grow through the hydrogel coated fabric material and into the moist soil 509, below the hydrogel coated fabric material in either the woven or non-woven form. The irrigation water travels through the material and evaporates at a slower pace then soil without the material, allowing the water and fertilizer to stay in the plant root zone for the plant to use longer. This conserves irrigation water and conserves fertilizer and demonstrates the purpose and usefulness of the disclosed invention.

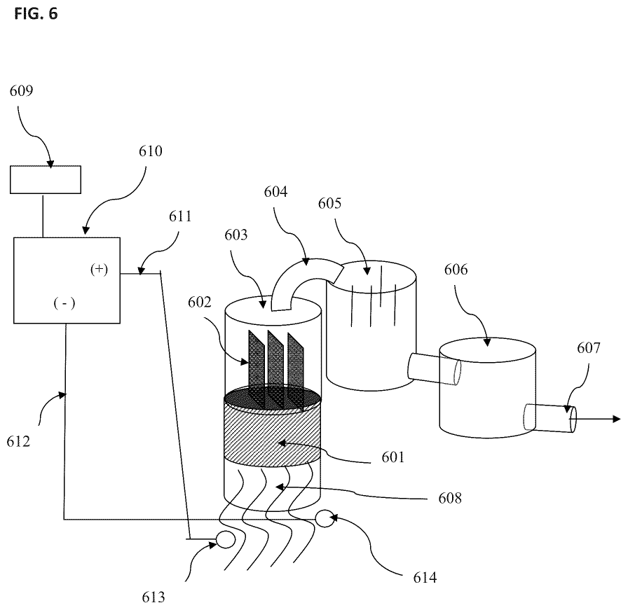

FIG. 6 illustrates a low energy passive water remediation system wherein the only power needed is to facilitate current for the electrochemical electrodes this can be accomplished with very little power. At least one positive electrode 613 in electrical connection 611 and at least one negative electrode. 614 in electrical connection 612 are used to apply electrical current to the pre-water intake 608 in order to isolate soluble ions at each electrode. Power is provided by a power source 609 such as a solar panel and the electrical current is controlled by the controller 610 used to control the electrical current and potential. Water enters evaporation tank shown as 601. Hydrogel coated materials 602 act as wicks with one end submerged in water drawing water into the high surface area of the polymer hydrogel coating of the woven or non-woven fibers to facilitate evaporation. The water vapor is collected in evaporation chamber 603 and travels through pipe 604 to condensation chamber 605 wherein the water vapor cools and condensates back into liquid water to be stored in storage tank 606 where it can be released as clean distilled water through pipe 607

The polymer material is a hydrogel composed of crosslinked polymers and is not soluble in a solvent such as water. The polymer is formulated by crosslinking two or more monomers and or polymers in a method so that once crosslinked they form a 3 dimensional non soluble polymer network. The crosslinking can be accomplished many ways that are well known in the art of polymer chemistry dependent on the polymer chains and reactive molecule species or catalyst used for the crosslinking reaction. Typically, a cross-link is a bond that links one polymer chain to another. They can be covalent bonds or ionic bonds. “Polymer chains” can refer to synthetic polymers or natural polymers (such as proteins). When the term “cross-linking” is used in the synthetic polymer science field, it usually refers to the use of cross-links to promote a difference in the polymers' physical properties. When “crosslinking” is used in the biological field, it refers to the use of a probe to link proteins together to check for protein—protein interactions, as well as other creative cross-linking methodologies.

Cross-linking is used in both synthetic polymer chemistry and in the biological sciences. Although the term is used to refer to the “linking of polymer chains” for both sciences, the extent of crosslinking and specificities of the crosslinking agents vary. Of course, with all science, there are overlaps, and the following delineations are a starting point to understanding the subtleties. When cross links are added to long rubber molecules, the flexibility decreases, the hardness increases and the melting point increases as well.

When polymer chains are linked together by cross-links, they lose some of their ability to move as individual polymer chains. For example, a liquid polymer (such as resin or even melted cheese which contains protein polymers) (where the chains are freely flowing) can be turned into a “solid” or “gel” by cross-linking the chains together.

In polymer chemistry, when a synthetic polymer is said to be “cross-linked”, it usually means that the entire bulk of the polymer has been exposed to the cross-linking method. The resulting modification of mechanical properties depends strongly on the cross-link density. Low cross-link densities decrease the viscosities of polymer melts. Intermediate cross-link densities transform gummy polymers into materials that have elastomeric properties and potentially high strengths. Very high cross-link densities can cause materials to become very rigid or glassy, such as phenol-formaldehyde materials.

Cross-links can be formed by chemical reactions that are initiated by heat, pressure, change in pH, or radiation. For example, mixing of an unpolymerized or partially polymerized resin with specific chemicals called crosslinking reagents results in a chemical reaction that forms cross-links. Cross-linking also can be induced in materials that are normally thermoplastic through exposure to a radiation source, such as electron beam exposure, gamma-radiation, or UV light. For example, electron beam processing is used to cross-link the C type of cross-linked polyethylene. Other types of cross-linked polyethylene are made by addition of peroxide during extruding (type A) or by addition of a cross-linking agent (e.g. vinyl-silane) and a catalyst during extruding and then performing a post-extrusion curing. The chemical process of vulcanization is a type of cross-linking that changes rubber to the hard, durable material associated with car and bike tires. This process is often called sulfur curing; the term vulcanization comes from Vulcan, the Roman god of fire. This is, however, a slower process. A typical car tire is cured for 15 minutes at 150° C. However, the time can be reduced by the addition of accelerators such as 2-benzothiazolethiol or tetramethylthiuram disulfide. Both of these contain a sulfur atom in the molecule that initiates the reaction of the sulfur chains with the rubber. Accelerators increase the rate of cure by catalyzing the addition of sulfur chains to the rubber molecules.

Cross-links are the characteristic property of thermosetting plastic materials. In most cases, cross-linking is irreversible, and the resulting thermosetting material will degrade or burn if heated, without melting. Especially in the case of commercially used plastics, once a substance is cross-linked, the product is very hard or impossible to recycle. In some cases, though, if the cross-link bonds are sufficiently different, chemically, from the bonds forming the polymers, the process can be reversed. Permanent hair wave solutions, for example, break and re-form naturally occurring cross-links (disulfide bonds) between protein chains in hair.

Chemical covalent cross-links are stable mechanically and thermally, so once formed are difficult to break. Therefore, cross-linked products like car tires cannot be recycled easily. A class of polymers known as thermoplastic elastomers rely on physical cross-links in their microstructure to achieve stability, and are widely used in non-tire applications, such as snowmobile tracks, and catheters for medical use. They offer a much wider range of properties than conventional cross-linked elastomers because the domains that act as cross-links are reversible, so can be reformed by heat. The stabilizing domains may be non-crystalline (as in styrene-butadiene block copolymers) or crystalline as in thermoplastic co-polyesters. The compound bis (triethoxysilylpropyl)tetrasulfide is a cross-linking agent: the siloxy groups link to silica and the polysulfide groups vulcanize with polyolefins.

Many polymers undergo oxidative cross-linking, typically when exposed to atmospheric oxygen. In some cases, this is undesirable and thus polymerization reactions may involve the use of an antioxidant to slow the formation of oxidative cross-links. In other cases, when formation of cross-links by oxidation is desirable, an oxidizer such as hydrogen peroxide may be used to speed up the process. The process of applying a permanent wave to hair is one example of oxidative cross-linking. In that process the disulfide bonds are reduced, typically using a mercaptan such as ammonium thioglycolate. Following this, the hair is curled and then ‘neutralized’. The neutralizer is typically a basic solution of hydrogen peroxide, which causes new disulfide bonds to form under conditions of oxidation, thus permanently fixing the hair into its new configuration.

It is possible to crosslink polymers and leave an excess of one or more unreacted reactive molecules. One example of this would be in an epoxide reaction where there is a ratio of one or more epoxy reactant molecules that is greater than the number of epoxides. After polymerization, this will leave an amount of unreacted reactive molecules used in the polymerization process that have not been used and can be calculated as mathematical ratios. In another epoxide reaction, a branched polymer with reactive molecules that do not react to the epoxide reaction may be mixed into the formulation of the epoxide wherein the branched polymer gets trapped or entangled within the reacted epoxy matrix. Another example would be to add into the epoxy mixture prior to polymerization a reactive molecule or material such as but not limited to activated carbon, Oxides such as of zinc or titanium, clays, nano powders that react with specific pollutants, Amines, Hydrogens, Carboxylates, Hydroxyls, Oxygen, Flourines, Thiols etc. this can additionally be used in reverse where some of the branched polymers are end capped with reactive Amines, Hydrogens, Carboxylates, Hydroxyls, Oxygen, Flourines, Thiols etc. to specifically target molecules in solution. The polymerization reaction can be done several ways such as epoxide reaction, condensation reaction, UV initiated reaction, Thermal reaction etc. and is not meant to limit the scope of the invention. The unreacted molecules that are left after the polymerization reaction or trapped in the polymer matrix are then able to react with water or other solvents and attract the one or more targeted molecules that are being recovered or removed from a solution.

The polymer Hydrogel in a preferred embodiment is applied in liquid form, pre-polymerization to a woven or nonwoven cloth, fabric, paper or other type of flexible substrate. The substrate can be made of natural materials, such as but not limited to cotton, burlap, coconut fibers or Synthetic fiber materials such as but not limited to polypropylene, polyethylene, polyester, and copolymer mixtures are all examples of synthetic fibers that can be used. Materials such as paper, thread or yarn that can additionally be coated with the polymer and stay flexible are preferred.

In another preferred embodiment, Woven mat or cloth with an open weave pattern or PICs Per Inch (PPI) ranging anywhere from but not limited to <1 to 1000 count of yarn and or thread and more specifically to a count of 1 to 12 PPI. The smaller the individual strand in the yarn or woven material the better as this increases surface area of the polymer coating and does not let the polymer break off and become particulate in the solvent solution.

In another preferred embodiment, braided fiber materials like rope and straps that can be used similar to wicks to purify the solvent where the solvent can travel along the length of the material in a desired direction, the polymers reactive molecules react with pollutants of target molecules and ultimately the solvent trickles out of the material in a purified state The larger the porosity of the polymer gel coating on these types of fabrics and materials the faster flowrate and chemical reaction saturation of the polymer coated materials.

In many instances the substrate is specific to the use of the material, in either the woven or nonwoven versions which may be used above or below the soil surface. In another preferred embodiment, the woven fabrics can be used for a landscape irrigation and agricultural irrigation functions. The woven fabric materials can be used as an aid to extend irrigation water dispersion or spread under the ground via the wicking process.

For example, in a preferred embodiment, the open weave provides several important functions, an open weave works best to allow plant root penetration through the mat and retain all the wicking advantages, the amount and formulation of polymer hydrogel coating on the material dictates speed of wicking, moisture retention and fertilizer retention etc., thereby reducing the amount of water needed due to underground water spread and evaporation reduction. The use of fertilizer is reduced due to the reduction of plant nutrients such as Ammonia, Nitrates, Nitrites and Phosphorous leaching through the soil and or running off the soil and into the watershed.

In another embodiment, the open weave also allows directionality of the water/solvent flow or wicking properties by utilizing two different sizes and or types of woven and or nonwoven yarns and threads into or as the weave material components. For example, a fine fiber yarn with many strands that is hydrophilic and or coated with polymer gel is woven as the components running the length of the material and a larger diameter hydrophobic material, that the polymer and or solvent does not coat well, is the lateral component of the weave. This builds directionality into the material, where the wicking properties follow the length of the fine fiber hydrophilic materials but does not follow the thicker weave hydrophobic component that is running angularly and or perpendicularly in the weave. There are many possible combinations of this type of woven materials and combinations and the examples are not meant to limit the scope of possible combinations of the invention.

Nonwoven material substrates can also wick water and solvents, just non-directionally or in all directions since there is no weave pattern. In one preferred embodiment to achieve directionality or application need in a certain area of the material, a pattern can be simply cut into or out of the material. In another embodiment a surfactant or polymer applied to the non-woven material can dictate the directionality of wicking properties by coating some areas of the material with hydrophilic surfactant or polymer coating where water or solvents wick and some areas with hydrophobic surfactants or polymers that inhibit the wicking, for example alternating stripes of hydrophilic and hydrophobic surfactant or polymer can be applied either by printing process and or spraying, stenciling etc., thereby creating wicking stripes across or along the length of the material.

In another embodiment, Hydrophobic surfactant or polymer only is applied to nonwoven hydrophilic material in multiple stripes allowing the material to wick naturally along the non-coated areas of the material or the opposite can be done where a hydrophobic nonwoven material is coated with a hydrophilic surfactant or polymer in stripes and the solvent will follow the hydrophilic stripes.

The ability to control the wicking direction is of particular importance when used on or under a sloped surface where you would want wicking of water to travel horizontally under the ground across the slope for max irrigation and water conservation, if you used the nonwoven material with no directionality under the soil surface irrigation water would follow the slope because the material has no directionality of wicking, the irrigation water would simply end up wicking to the bottom of a slope causing seepage and even mud flow to the bottom of the slope.

In another preferred embodiment, the open weave material is placed just under, preferably 1-3 inches below the soil surface around a plant. The open weave allows irrigation or rain water to penetrate through the mat but then as the polymer coating starts to swell with water it creates a restricted surface and an enhanced condensation area in and under the mat, this process slows down the irrigation water evaporation rate from the soil around the plant and typically conserves over 50% of the irrigation water the plant needs. The polymer coated mats can be used for potted plants, gardens, farms, under turf or sod etc. anywhere that irrigation is used.

In another embodiment, the material has irrigation system, micro irrigation or micro porous tubes attached to it by weaving or sowing or heat sealing, gluing or any other method of attachment of the irrigation water conduit tubing to the woven or nonwoven material in such a way as to allow the material with the irrigation tubes to be rolled up for transport and stocking convenience and then rolled out for installation. The irrigation tubing is situated such that the tubing can be capped or attached, interconnected and or coupled to other tubing at the ends of the roll if the tubing is attached length wise. Alternately the irrigation tubing is situated such that the tubing can be capped or attached, interconnected and or coupled to other tubing along the width of the material. The irrigation tubing delivers water and or water with nutrients to locations on the material the material then allows the water to travel via wicking process to wider areas more efficiently and do not get root bound or plugged up thereby reducing water use and maintenance over an irrigated area.

In another preferred embodiment, the substrate material is made of a natural fiber such as Jute, Sisal, Hemp, Hessian, cotton etc. and or synthetic fibers. The fabric is coated with a hydrogel polymer that has excess reactive molecule sites, via spray, flow or dip tank, the excess polymer is squeezed off by rollers, flexible wiping blades and or squeegees etc. to obtain a specific amount of polymer loaded onto the material per square foot, meter or other measurement and allowed to cure and then re rolled to a specific length and cut off.

In another preferred embodiment, the substrate material is made of a natural fiber such as Jute, Sisal, Hemp, Hessian, cotton etc. and or synthetic fibers. The fabric is coated with a hydrogel polymer that has excess reactive molecule sites and is loaded with a clay, Nano-clay and or other mineral, via spray, flow or dip tank the excess polymer is squeezed off by rollers, flexible wiping blades and or squeegees etc. so that a specific amount of polymer and clay, Nano-clay or other mineral is loaded onto the material per square foot, meter or other measurement and allowed to cure and then re rolled to a specific length and cut off.

In another preferred embodiment, the substrate material is made of a natural fiber such as Jute, Sisal, Hemp, Hessian, cotton etc. and or synthetic fibers. The fabric is coated with a hydrogel polymer that has excess reactive molecule sites and is loaded with a clay and or other mineral, via spray, flow or dip tank the excess polymer is squeezed off by rollers, flexible wiping blades and or squeegees etc. so that a specific amount of polymer and clay or other mineral is loaded onto the material per square foot, meter or other measurement and then allowed to cure and then re rolled to a specific length and cut off. Alternately the clay and or other minerals can be sprayed on after the polymer is applied but prior to curing

In another preferred embodiment, the substrate material is made of a natural fiber such as Jute, Sisal, Hemp, Hessian, cotton etc. and or synthetic fibers. The fabric is coated with a hydrogel polymer that has excess reactive molecule sites and is loaded with a clay and or other mineral that has been soaked and or loaded with soil bacteria and or Nitrobacteria and or enzymes, via spray, flow or dip tank the excess polymer is squeezed off by rollers, flexible wiping blades and or squeegees etc. so that a specific amount of polymer and clay or other mineral is loaded onto the material per square foot, meter or other measurement and then allowed to cure and then re rolled to a specific length and cut off. Alternately the clay and or other minerals loaded with bacteria and or nitro bacteria and or enzymes can be sprayed on after the polymer is applied but prior to curing. Once cured the material may contain everything it needs to support plant life over extended periods with or without soil.

In other embodiments fertilizer is added to the polymer matrix by including it in the formulation of the polymer or applying as the polymer is applied to the material substrate. In yet other embodiments fertilizer and or seeds can be applied to the material substrate with or without the clays, minerals, bacterial etc. In yet another embodiment version the pH of the polymer can be adjusted via formulation to a specific range between pH 3-9, more specifically to a range between pH 6-8 and even more specifically to a set pH of 6.0, 6.5, 7.0, 7.5, 8.0 or any number in between these.

In another embodiment, the polymer coated substrate material can be laid out in agriculture runoff areas, catch ponds etc. With the purpose of stripping any fertilizer (Ammonia, Nitrates, Nitrites, Phosphorous, Potassium) out of the runoff water.

In another preferred embodiment, the polymer coated substrate material can be used to remove metals solubilized in water.

In another preferred embodiment, the polymer coated substrate material can be used to remove chemicals solubilized in water.

In another preferred embodiment, the polymer coated substrate material can be used to remove acids solubilized in water an example of this would be carbonic acid or CO2 dissolved in sea water.

In another embodiment, the polymer coated substrate material is manufactured as a long continuous belt and or loop that is exposed to the water or solvent or air that is polluted. The pollutant is attracted to the material and removed from the water or solvent or air and then processed so that the belt or loop can be reused. This is accomplished via chemical and or electrochemical processing in solution. Using a chemical or electrochemical process with a stronger charge either in the solution or at an electrode than the belt of material has will encourage the pollutant, metal, chemical or acid to detach from the polymer coated substrate material belt and collect at the stronger charge. This allows for the polymer coated substrate to be reused over and over thereby reducing the cost of the cleanup materials used, and dramatically reduces waste materials and brines when cleaning polluted and or brackish water. This process can be accomplished simultaneously so that a portable multi tank, self-contained unit can be moved to locations where pollution occurs and used as needed or it can be built as a permanent structure with several continuous belts running simultaneously as well as belts with different polymer formulations that remove different pollutants.

Nothing in this description is meant to limit the scope and use of the invention.

What is claimed is:

1. A woven fabric formed of fabric fibers or threads coated with a hydrogel, wherein said hydrogel is not crosslinked or is partially crosslinked to the fabric fibers or thread, wherein the hydrogel has a number of excess reactive molecules that are available for a reaction with one or more molecules solvated in an aqueous solution, and wherein the reactive molecules of the hydrogel can reversibly bond with the molecules solvated in an aqueous solution, such that the reactive molecules of the hydrogel attract the molecules solvated in aqueous solution when the hydrogel coated fabric substrate is exposed to an aqueous solution.

2. The woven fabric of claim 1 wherein the hydrogel is an epoxy and hydrophilic, and/or wherein the fabric fibers or thread are made of a synthetic material selected from the group consisting of polypropylene, polyethylene, polyester, and a copolymer mixtures thereof, or a natural fiber material selected from the group consisting of Jute, Sisal, Hemp, Hessian, cotton, bamboo and a mixture thereof.

3. The woven fabric of claim 1 wherein the fabric fibers or threads are all of similar size in all of the weave directions, or are of two or more different sizes, wherein at least one size of fabric fibers or thread are woven in one weave direction, and at least one different size of fabric fibers or thread are woven in a different direction to the first size of fabric fibers, or are of two or more different sizes, wherein at least one size of fabric fibers or thread is hydrophilic and a different size of fabric fibers or thread are hydrophobic.

4. The woven fabric of claim 1 in a form of a continuous loop belt.

5. A non-woven substrate in a form of fabric fibers or threads coated with a hydrogel, when said hydrogel is not crosslinked or is partially crosslinked to the fabric fibers or thread and includes at least one of the following:
wherein the hydrogel is an epoxy and hydrophilic;
wherein the fabric is made of a synthetic material selected from the group consisting of polypropylene, polyethylene, polyester, and a copolymer mixture thereof;
wherein the fabric is made of natural fiber material selected from the group consisting of Jute, Sisal, Hemp, Hessian, cotton, bamboo and a mixture thereof; and
wherein the substrate is a paper.

6. The non-woven fabric of claim 5 wherein the fabric fibers are all of similar size, or wherein the fabric fibers are of two or more different sizes, and optionally wherein the substrate is perforated in a geometric pattern, removing between 10-90 percent of the substrate, or wherein the substrate is coated in alternating stripes of hydrophilic hydrogel and hydrophobic polymer gel.

7. The substrate of claim 6 in a form of a continuous loop belt.

8. A method of removing solvated molecules from solution and recovering the molecules and the solution separately using a substrate coated with, a porous polymer gel wherein the polymer gel has a number of excess reactive molecules that are available for a reaction with one or more molecules solvated in a solution, and wherein the reactive molecules of the porous polymer gel can reversibly bond with the molecules solvated in a solution, such that the reactive molecules of the polymer gel attract and remove the molecules solvated in solution when the substrate is exposed to the solution and; wherein the removed molecules can be recovered from the substrate and the substrate can be reused once the molecules are recovered.

9. The method of claim 8 wherein the porous polymer gel coated substrate can be further recharged in another solution, and/or wherein the molecules are recovered by one or more electrochemical reaction.

10. A solution remediation system comprising a substrate coated with a hydrogel having excess reactive molecules, wherein the substrate is one or more components of a continuous moving loop belt and the belt is exposed to one or more solutions in at least one tank with an inlet and outlet, the hydrogel excess reactive molecules reversibly bond, attract, adsorb or remove solvated molecules from the solution in the tank, the molecules removed from solution are recovered from the hydrogel coated substrate by exposing the continuous loop belt to another solution in at least one tank or process in sequence with one or more of the following steps:
drying,
heating,
chilling
electrochemical processes,
chemical processes,
rinsing,
the excess reactive molecules of the hydrogel coated substrate are recharged by at least one of the following;
drying,
heating,
chilling
electrochemical processes,
chemical processes,
rinsing, and
the excess reactive molecule hydrogel coated substrate continuous loop belt is re-exposed to solution to be remediated.

11. The remediation system of claim 10 wherein the continuous moving loop belt is exposed to evaporation chamber wherein the solution is evaporated from continuous belt, cooled and condensed to recover the solution.

12. The solution remediation system of claim 10 wherein the solvated molecules to be recovered consist of one or more salts, metals, ions, cations, carbons, CO₂, acids, bases, ammonia, nitrates, nitrites, phosphorus, potassium, oil.

13. The solution remediation system of claim 10 wherein the inlet has a positive and negative electrodes in electrical connection with a power source and placed before the tank inlet on opposite sides of a tube made of ion separator material attached to the inlet, and/or wherein the one or more tanks have two or more electrodes in electrical connection with a power source and said tank has at least one ion separator isolating at least one electrode from the other, and/or wherein the electrochemical process has a positive and negative electrode placed on opposite sides of the continuous belt, wherein a charge applied to the electrodes generate a charge dynamic that attracts and releases the molecules recovered from solution by said continuous loop belt.

14. A passive solution remediation system wherein a substrate of fibers running predominately in one direction and coated with a hydrogel are placed in such a manner that one end of the substrate is placed in a solution to be remediated and the opposite end is placed in a collection container at a lower level than the solution to be remediated and allowed to siphon or wick the solution from the higher elevated solution down to the lower solution container, and wherein the polymer coated substrate preferably is placed inside a tube to stop evaporation of the solution from the hydrogel coated fibers.

15. A method of conserving irrigation water and/or fixing nitrogen in the soil, comprising placing a substrate coated with a polymer gel below the soil surface or planting media surface of one or more plants at a depth ranging from one tenth (0.10) of an inch to forty-eight (48) inches deep, preferably at a depth ranging between one and three inches deep and wherein the substrate is coated with a polymer gel that is hydrophilic, the polymer gel coated substrate has openings for plant roots to grow through, the polymer gel coated substrate allows irrigation water to pass through it when plant is being irrigated, and then slows down the rate of water evaporation from the soil or planting media.

16. The method of claim 15, wherein the polymer gel coating the substrate contains excess reactive molecules that adsorb, bond or attract at least one dissolved fertilizer chemical component.

17. The method of claim 15, wherein the polymer gel on said substrate is branched to improve reactions between amines and nitrogen in the presence of water.

18. The woven fabric of claim 1, wherein the woven fabric has an open weave with 1-100 threads per inch, and preferably an open weave of between 2 and 14 threads per inch and coated with a hydrogel.

19. The non-woven material of claim 5 wherein the non-woven substrate fabric is perforated to remove a range of 10-90 percent of the substrate, preferably 30-60 percent of the substrate, coated with a hydrogel.

20. A sub soil surface installed irrigation water conservation system comprising a woven fabric of claim 1, having at least one length of drip irrigation tubing attached or in contact with the fabric or substrate in fluid connection with the irrigation system.

21. A sub soil surface installed irrigation water conservation system comprising a woven fabric of claim 5, having at least one length of drip irrigation tubing attached or in contact with the fabric or substrate in fluid connection with the irrigation system.
